(19) United States
(12) Patent Application Publication
(10) Pub. No.: US 2018/0108252 A1
(43) Pub. Date: Apr. 19, 2018

(54) DEVICE KNOWN AS REAL TIME TOTAL CONTROL DIGITAL TACHOGRAPH (TCDT) FOR VEHICLE AND OTHER NEARBY VEHICLES BY MEANS OF CAMERAS AND MOBILE CONNECTIONS

(71) Applicant: Marcelo Pividori, Avellaneda (AR)

(72) Inventor: Marcelo Pividori, Avellaneda (AR)

(21) Appl. No.: 15/561,710

(22) PCT Filed: Jun. 28, 2016
(86) PCT No.: PCT/IB2016/053841

§ 371 Date: Sep. 26, 2017

(30) Foreign Application Priority Data
Jul. 3, 2015 (AR) 2015-01-02138

(51) Int. Cl. G08G 1/01; G07C 5/08; G08G 1/0962; G07C 5/00; G06F 3/0488

(52) U.S. Cl. CPC G08G 1/0133; G07C 5/08; B60R 2001/1253; G07C 5/008; G06F 3/0488; G08G 1/0962

(57) ABSTRACT

The present invention relates to a Total Control Digital Tachograph (TCDT) that controls a vehicle designed to automatically and permanently generate control of the unit, the manner in which a driver drives the unit and a device for its monitoring and evolution.

### CROSS REFERENCE TO RELATED APPLICATION

This application is a national stage entry of PCT/IB2016/053841 filed Jun. 28, 2016, under the International Convention claiming priority over Argentinean Patent Application No. 20150102138 filed Jul. 3, 2015.

### FIELD OF THE INVENTION

The present invention pertains to the field of devices used for vehicle control, particularly equipment installed in any vehicle, more particularly equipment providing information in real and/or delayed time to be relayed from the vehicle to a control center.

### STATE OF THE ART

The Digital Tachograph (DT) is an electronic device for recording events whilst driving vehicles and its overall function is to monitor compliance regarding speed and driving times as well as resting periods of the driver, contributing to safeguard the security of the passenger(s) and the driver(s).

The predecessor of the Digital Tachograph (DT) is the Analog Tachograph (AT), which is expected to be replaced in the immediate future in freight and passenger vehicles, as the DT also meets the same standards or regulations as the AT, but with the storage capacity of data in digital format on internal solid state memory and driving cards, typical of the Digital Tachograph.

The DT is similar in appearance to the AT, but it consists of a central control device, a speed/distance sensor and Tachograph cards.

The AT disks, which are paper disks on which the driving information has been printed out, have been replaced by smart cards, based on a chip, which store the driving information, providing access to several functions according to the user profile, (driver, company, controlling body or workshop). The stored information regarding times and speeds is the same as that currently displayed on analog Tachographs but virtually impossible to manipulate.

The equipment is installed in the driver's cabin so that the driver can visualize and manage it. The equipment communicates with the sensor, which will be typically installed in the gearbox, connected to the unit by means of a cable.

Current DTs have an activity selector to provide information when the driver takes his rest or other tasks, they control speed, and other driving habits, errors in the system and data transfers. This information is used to verify compliance with norms regarding driving times and resting periods and comprises one of the most important advantages of the Tachograph.

Furthermore, the tachographs typically have a GPS and/or a speed sensor, a processor, a solid state memory, several data, input/output links, a database with geo-referenced vector cartographic information and an application program, typical of the Tachograph, which in turn builds up a database.

This data is stored both in the memory of the tachograph as well as on the driver's card. The tachograph has the capacity to store retroactive data and keep it on the internal memory for a year, whilst the driver's cards only guarantee the storage of data for thirty days.

When both time periods have been exceeded, new data is recorded replacing the older data, both on the driver's card as well as on the memory of the Tachometer after the one year period mentioned. Typically, the card that identifies the driver must remain at all times within the reader, otherwise the event log will post an alarm or the DT will not allow the engine to start.

The events collected by the DT are used to keep an inviolable registry of data with restricted access, together with the date, time, geographical coordinates, and driving speed compared to the maximum speed; the start and finish of correct or incorrect operation events are also stored together with the date, time and last/first valid position; the nonvolatile memory stores the above mentioned values on a database.

In the current DT, the owner of the vehicle is responsible for reading data both from the tachograph as well as from the driver's card of those drivers who have used it with sufficient frequency to prevent its loss. Likewise, it is necessary to store data over a one year period and make it available to the authorities when so required.

Currently there are many systems and equipments available for vehicular traffic control, which attempt to generate the obligation to comply with traffic regulations, in order to improve road safety in cities and roads across the country.

Existing controls can be divided into two main groups:

1) Controls located on and/or inside the vehicle, and

2) Controls located on the outside of the vehicle and not an integral part of its structure.

In this first category, the most common are equipments which form part of the vehicle and are required by Law, Ordinance or Regulation, such as the CN (Speed Limit Control) and the Digital or Analog Tachographs (DT or AT). Currently the limitation of these systems is that they only apply to a very limited number of vehicle types, the DT in public transport and the AT in some types of cargo trucks. Control of the vehicle, the driver and the driving of the vehicle in the above mentioned systems are limited by a technology that currently has been largely overcome and currently allows the incorporation of a sequence of controls and compliance requirements that are reflected in this invention.

In the category of control systems which are external to the vehicle, we find speed measuring systems by means of radar; these are systems which use electromagnetic waves to measure the speeds of moving objects. The latest speed detectors use pulsed laser light, commonly referred to as LIDAR, rather than radio waves. LIDAR detection, however, is not as effective as radar detection as the scanning beam is highly focused. Despite the advent of the LIDAR speed detector, radar still sells more due to the relative cost ratio.

The limitations of these systems are that they are spot checks and localized, so that vehicles end up complying with the driving regulations only in those controlled areas without being able to convert the criteria of proper driving into a habit as far as drivers are concerned, despite the imposition of legal sanctions.

Therefore, it is necessary to have a tachograph which comprises interconnectivity and which allows for a greater functional range.

### SUMMARY OF THE INVENTION

The object of the present invention relates to a Total Control Digital Tachograph (TCDT), which complies with the same Directives and/or Regulations as the Digital Tachograph, controlling speed, driving times and resting periods of the fleet personnel, in addition, it includes pre-start trip controls of the vehicle as well as of the driver, provides a driving control system based on speed limits, vehicle weight, acceleration, etc. Taking into account the location of the vehicle and, in accordance with traffic regulations of the location where the vehicle is being used, provides the driver with audible and/or visible signals upon failure to comply with those regulations, which are recorded on the TCDT. The TCDT likewise incorporates the use of one or more cameras to record video in real time from the driver's cabin as well as the environment of the unit, and enables the driver to capture images of traffic offenses of other vehicles in its environment and report these offenses to the system in real time.

In order to carry out the above mentioned in real time, the TCDT comprises a mobile communications module (MCM) which enables it to link with a Central Control Station (CCS) by means of a network, for the control and management of its own Real Time Vehicle Control System (RTVCS) which these TCDTs form a part of.

For pre-trip controls, and using the MCM module, the TCDT also comprises a fingerprint reader which will identify the driver, verifying that the driver complies with the necessary and sufficient conditions for driving that unit. The TCDT verifies, according to company records and the driver's card, the validity of: the national and/or international driving license, vehicle authorization to circulate, the driver's card, files regarding the validity of the driver's health, eyesight, hearing, and other necessary check-ups. The TCDT will verify and authorize the origin and destination of the trip as well as the type of load to be transported.

Based on these data the TCDT generates a validation for the use of the unit, prior to the control regarding the availability and approval of compliance with the load to a server of the RTVCS system, as well as the necessary documentation to carry out the scheduled and/or alternative itinerary: RUTA Certificate, Mandatory technical inspection, Identification card of the unit, Certificate of current insurance coverage, Document or letter supporting the transport of the load, additional requirements or Certificates according to the type of load, in the case of international trips, all necessary company documentation, the unit and the load required to this effect, etc.

This likewise enables the equipment to provide information for other private control systems, making it possible for the TCDT to replace equipment currently in use in vehicles such as AVL (English acronym for Automatic Vehicle Location) browsers, among others.

This will allow to efficiently control other units which currently already have controls, and also convert the controlled vehicle into a controller of other vehicles, generating in drivers of all types of units, with or without TCDT, a feeling of being constantly monitored and thereby generating a greater subconscious obligation to comply with traffic laws, reducing accidents, and in the event of an accident, speed assistance to them, as well as being able to analyze these accidents at a later date in order to carry out preventive measures or future corrections.

### BRIEF DESCRIPTION OF THE FIGURES

FIG. 1 shows a schematic diagram of the connections of a main processor of a preferred embodiment of the TCDT according to the present invention.

FIG. 2 shows the possible locations of said constitutive parts of the TCDT of FIG. 1 in a particular type of vehicle, in this case the cabin of a truck.

FIG. 3 shows a diagram of the CPU for control and communication of the TCDT of FIG. 1 wherein the connections between its constitutive parts are detailed.

FIG. 4 shows the connectivity of equipment according to FIG. 1 installed in a vehicle with a Central Control Station (CCS) sending and receiving data in a highway situation.

FIG. 5 shows the connectivity of multiple equipments according to FIG. 1 installed in several vehicles with a Central Control Station (CCS) sending and receiving data in a highway situation.

FIG. 6 shows a screen of a V&D video sequence for the purposes of determining traffic offenses.

FIG. 7 shows another screen of the V&D video sequence of FIG. 6 for the purposes of determining traffic offenses.

FIG. 8 A shows both private and mandatory currently existing systems and equipment under Ordinance or Regulations.

FIG. 8 B schematically shows a new system for Real Time Vehicle Control System (RTVCS) according to a preferred embodiment for the optimal use of the present invention which comprises control of traffic offenses on the highway of vehicles according to applications by law (Zone A) and the option to allow as well the use on private applications (Zone B).

FIG. 9 shows a block diagram of the elements which comprise a TCDT according to a preferred embodiment of the present invention.

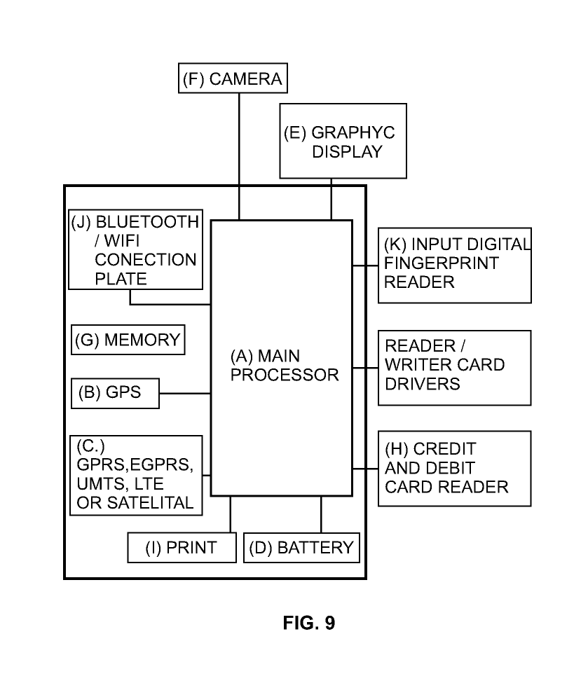

FIG. 10 shows the location of the camera as a constitutive part of the TCDT of FIG. 1 in a particular type of vehicle, in this case the cabin of a car.

FIG. 11 schematically shows the way in which the RTVCS system enables a “selective” control on the road of units having TCDT with reports of existing offenses, using a Cordless Tool for Vehicular Control, hereafter known as CTVC, which enables linking to the RTVCS system as well as establishing a connection with the TCDT of the approaching vehicle by means of Bluetooth and/or WiFi.

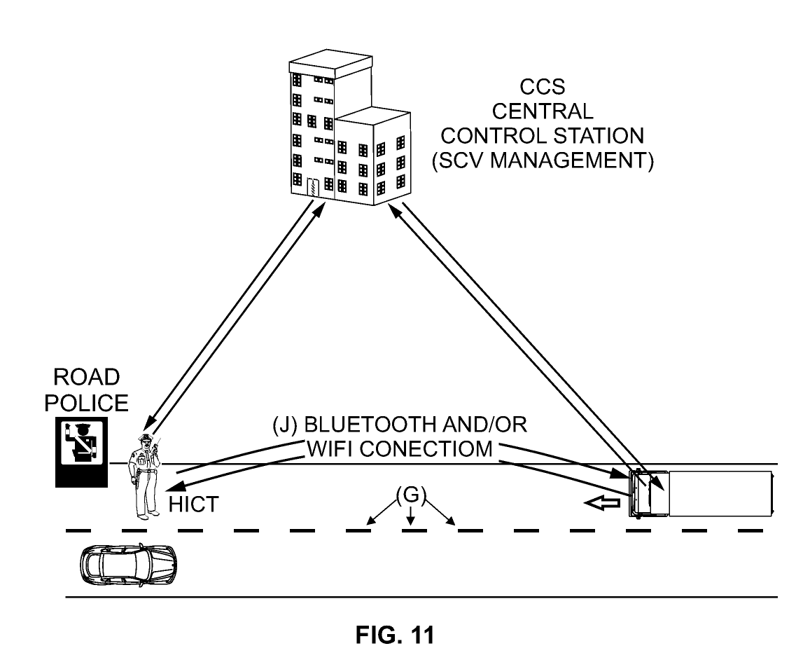

FIG. 12 shows a schematic diagram of the constitutive parts of a preferred embodiment of the CTVC according to the present invention.

### DETAILED DESCRIPTION OF THE INVENTION

The object of the present invention is a Total Control Digital Tachograph (TCDT), to control a vehicle applicable to all types of units and all types of applications designed to automatically and permanently generate control of the unit, the manner in which a driver drives the unit and a means for its monitoring and evolution. It meets the same standards and set of laws as the DT, but differs from the DT in that there are added controls to the unit and the driver, as well as also establishing how the unit is being driven related to that driver, which can be analyzed during the trip or subsequently thereto; likewise, said control can be extended to the control or observation of other nearby units and the latter can be requested remotely from the CCS or reported in a very simple manner by the driver himself.

The TCDT differs from the DT in that it adds a communications module (MCM), based on data packets, which enables a bidirectional transmission by means of a mobile telephone network, and/or by satellite, in addition, it adds one or more digital video recording cameras located in the cabin of the unit and on the outside of the unit: in front, on both sides and the back of the unit, a multidirectional acceleration and impact sensor, a fingerprint reader, a Bluetooth and/or WiFi connection plate, a graphic display (touch screen), and a keypad, from which the driver can generate reports of traffic offenses by third parties, and transmit them to the CCS.

Additionally, the TCDT provides two USB data outputs whose purpose would be to have access to the TCDT so that inspections both in the city as well as on the road can be carried out by the relevant authorities by means of an appropriate reader, thus avoiding misunderstandings and false reports. Additionally a printer, a credit or debit card reader, etc. can be connected or added using the USB.

Thus, the TCDT has more controls as compared to those available in the DT described in the prior art.

When implementing these additional advantages, the TCDT forms part of a Real Time Vehicle Control System, hereafter known as RTVCS, managed from the CCS, which enables it to carry out control of the correct use of the vehicles of an entire vehicle fleet and of those vehicles that may endanger the environment of each one of them.

All the aforementioned provided by the use of at least two cameras and the driver's own choice to carry out the corresponding reports by only pressing a key of the TCDT Tachograph, which will automatically send this report.

All the aforementioned turns the TCDT into a permanent control device in real time as well as retroactive of our vehicle in reference to the internal aspects of driving, mechanics and safety and in reference to our own faults and/or those of others that could place our driver, vehicle, load and company at a potential risk of accident, not to mention the invaluable assistance in improving compliance with traffic laws and safety.

Added to this ease of analysis and instant transfer of information, the driver has access to a push button provided in the cabin, in an easily accessible location (e.g. switch for operating lights), which we will call Driver's Push Button (DPB), conversely, the driver can also press a function on the touch screen, which will generate a report of an offense by a third party, which will consist of a video from the cameras as from a time prior to the report until a time after the report (configurable times). In addition to the video, the device will also add vehicle and GPS data which, once it is input automatically into the RTVCS system from the CCS, will be processed to identify and record the offense carried out by the third party.

Another aspect of the invention is that the TCDT, will, depending on the conditions permitted in the place and time where the vehicle is located, and in case of exceeding or failing to meet the limits established in the maps which are uploaded and updated in the TCDT, generate notices of offenses to the driver, and in case the offense is not corrected, implement a report directly to the CCS.

Regulations or laws that legislate on the characteristics and uses of the Tachograph vary according to each country. In Argentina, Decree 1716/2008 approves the regulation of the National Traffic and National Security Law No 26,363 which implements the use of tachographs in Freight and Passenger Transport.

On the other hand, in the European Union tachographs should have been installed in vehicles to which Regulation (EC) No 561/2006 applies. Regulation (EEC) No 3821/85 establishes a series of provisions regarding the manufacture, installation, usage and testing of tachographs. This Regulation has been substantially amended several times. Regulation (EU) No 165/2014 of the European Parliament and the Council of Feb. 4, 2014 regarding tachographs in road transport, repealed Regulation (EEC) No 3821/85 regarding control apparatus in the field of road transport and modified Regulation (EC) No 561/2006 of the European Parliament and the Council regarding the harmonization of certain social legislation relating to the road transport sector and some of the changes in this regulation aim to reduce the administrative burden carried by transport companies.

For the correct installation and implementation of the characteristic features of the TCDT, it should be noted that, since this equipment allows to expand and improve the manner in which to carry out controls on transport units, and taking into consideration that the level of requirements of the performance features of these units can be expanded and/or decreased, the Directive or Regulation should be adjusted so as to carry out what is intended, and the unit must also be able to be accommodated to this Regulation.

The main addition of the TCDT is the use of digital video footage in real time, which also enables to extend the above mentioned control of driving to other nearby units, whether they have such devices installed or not.

This will enable to efficiently control other units that do not have this device, as well as converting the controlled vehicle into the controller of other vehicles, generating the feeling that everybody is being watched by everybody constantly and thus generating a greater obligation by the automotive fleet to comply with traffic laws around the country in order to achieve a decrease in the accident rate. In addition, and as an added achievement in the event that an accident occurs, be able to help achieve greater speed and effectiveness in giving help, as well as warning other units and preventing accidents. Likewise, regarding the help that can be provided in the demarcation of responsibilities and in turn providing more information and accuracy of events in the tasks of expertise or legal actions and information for insurance companies.

Therefore, the primary objective of the TCDT of the present invention is to control the vehicle, the manner of driving to which the vehicle is subjected by the drivers assigned to the vehicle, as well as to control other vehicles located in its environment by means of digital video cameras associated to the TCDT, said feature is added to the traditional controls of the current tachographs.

The TCDT adds controls known as Preliminary Validation of Departure (PVD) which relate to the control of the unit with reference to its mechanical operation, validating the driver to drive this unit verifying the validity of: the national and/or international driving license, authorization enabling the vehicle to circulate, driver's card, files on the validity of the driver's health, eyesight, hearing, and other necessary check-ups.

In addition, the TCDT verifies the vehicle and the scheduled trip: origin and destination of the trip, RUTA Certificate, Mandatory technical inspection, Identification card of the unit, Certificate of current insurance coverage, the type of load to be transported, Document or letter supporting the transport of the load, Additional requirements or Certificates according to the type of load, in the case of international trips, all necessary documentation of the company, the unit and the load, etc. All this information will be gathered by the TCDT Tachograph, by means of the link through the RTVCS System with the Central Control Station (CCS), using the MCM module, and therefore it is the duty of the owner to keep this information updated, which is done by inputting the information into the RTVCS system. The system will facilitate this, making up a guide of the necessary information to update according to the vehicle, driver or type of trip or transportation to be made. Thus the CCS will be equipped with a database that is constantly updated and which will provide all necessary information on the companies, clients, vehicles and drivers as well as all the information on their transport or trip operations. At each change or addition introduced to the information, the CCS updates such data instantly in the memory of every TCDT of every mobile unit using the MCM module of the TCDTs.

In addition, the TCDT provides the possibility to monitor both remotely and in real time or deferred time the compliance by the driver of the driving rules of the company, it allows to view the driver in the cabin, the state of the load, and the parameters of the load, (for example the temperature in transport of perishable substances), control of the operating parameters of the engine, all in real time.

The TCDT has some elements which are common to digital tachographs, but incorporates new elements or new functions to these, such as:

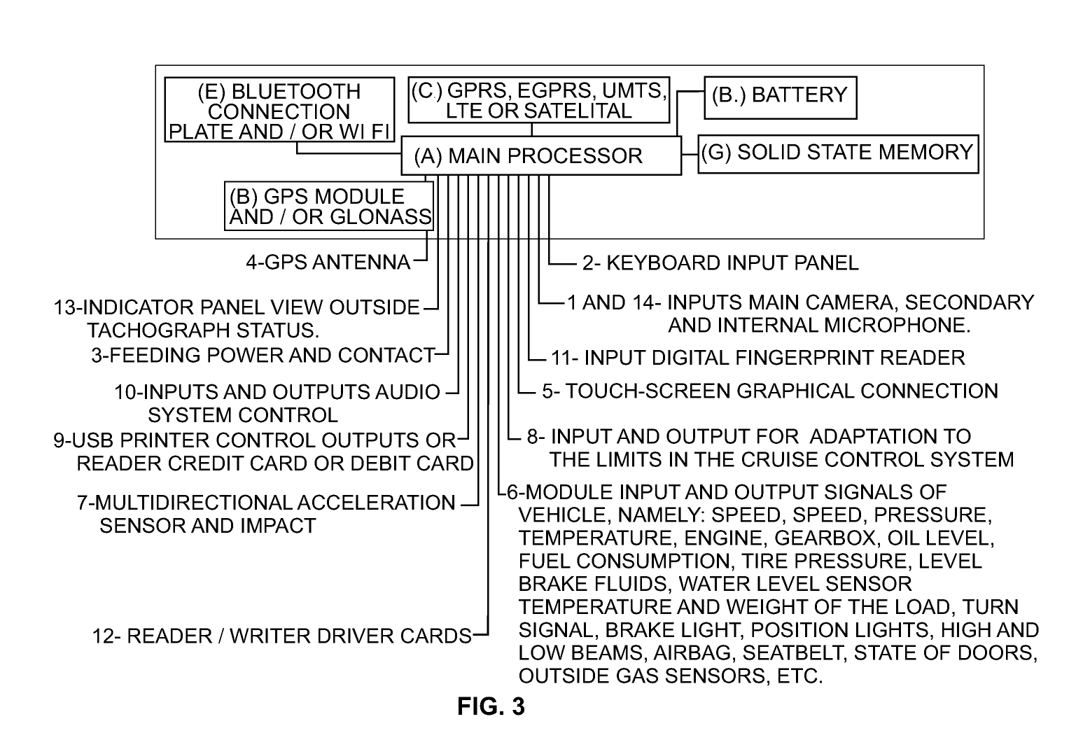

1) A GPS (acronym in English for Global Positioning Device) and/or GLONASS (acronym in Russian for Global'naya Navigatsionnaya Sputnikovaya Sistema), a Global Satellite Navigation System (GNSS) developed by the Soviet Union, and currently administered by the Russian Federation and which is the counterpart of the American GPS and the European Galileo, and/or the Galileo (B, FIG. 3) which is a global satellite navigation system developed by the European Union (EU), in order to avoid dependence on the GPS and GLONASS systems, and unlike these two, the Galileo is for civilian use. Any of these systems enable to determine the position of a unit, the time, direction and speed of the same, which will be input into the TCDT.

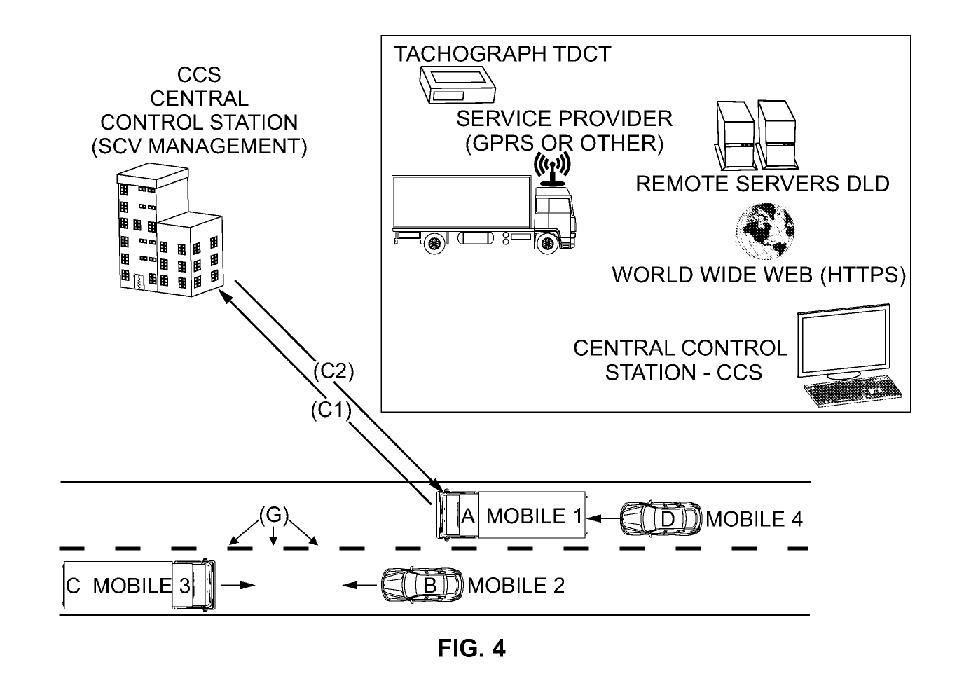

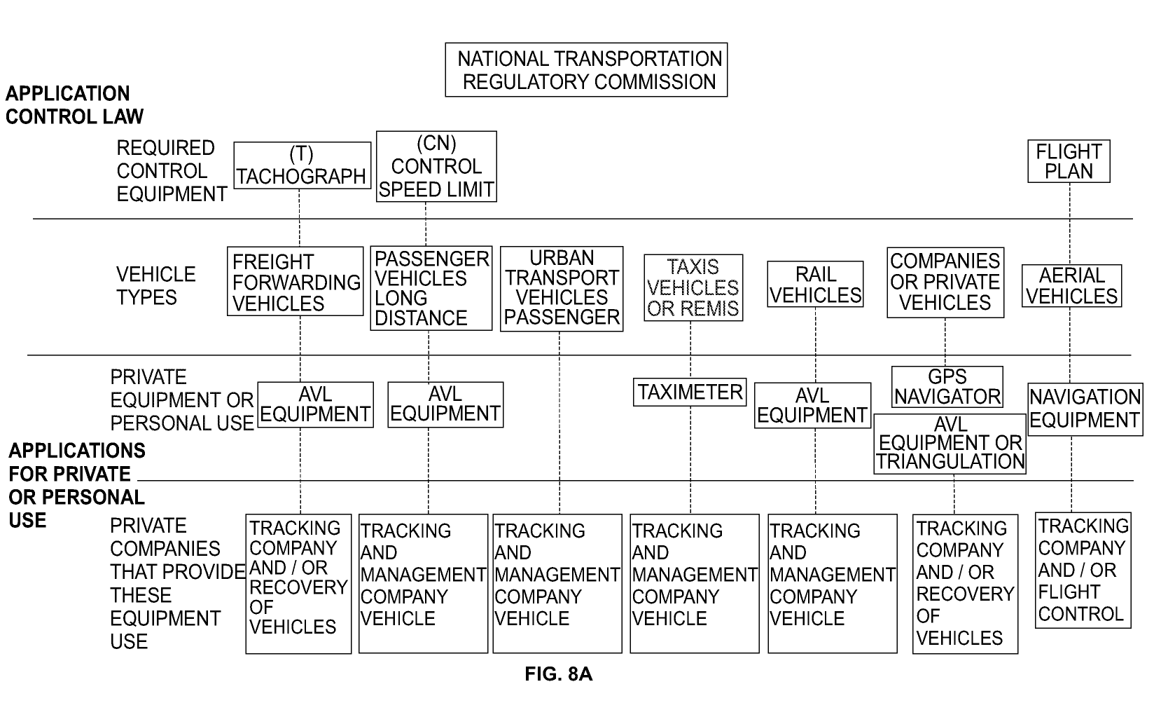

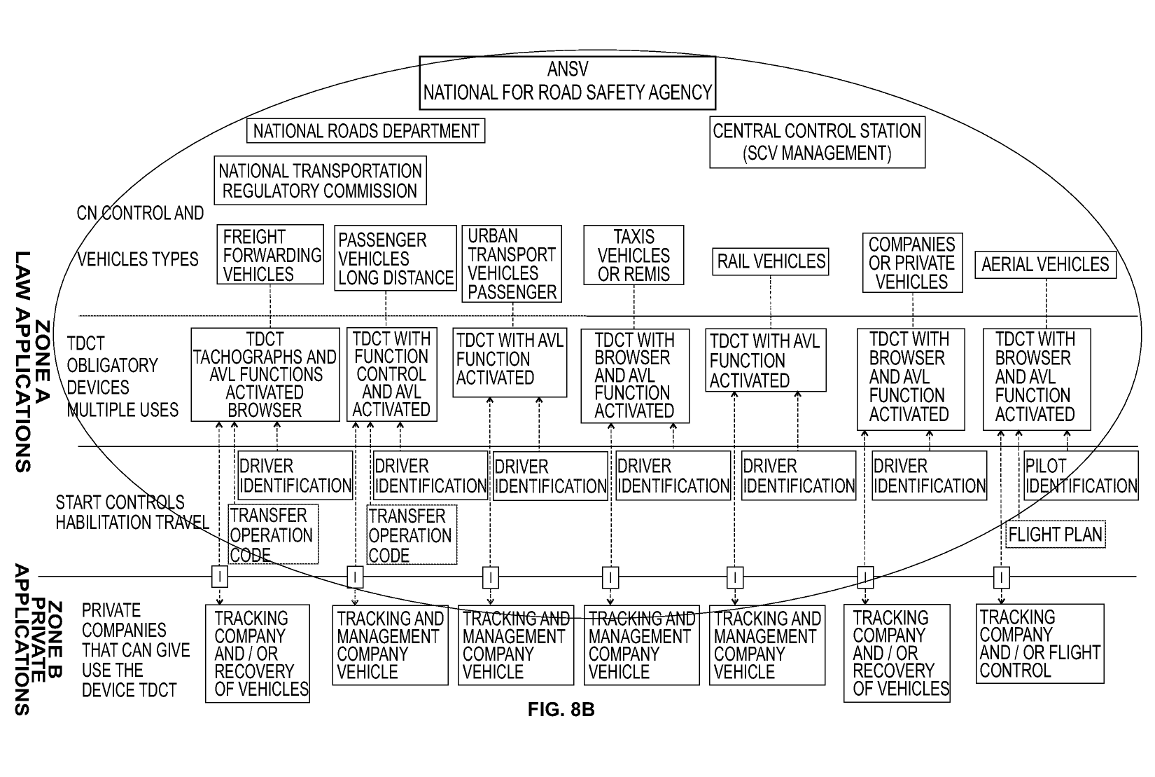

2) An MCM communication module, of the GPR (acronym for General Packet Radio Service) type, or general packet radio service created in the 80s is an extension of the Global System for Vehicle Communications (acronym for Global System for Vehicle Communications or GSM), EDGE/EGPRS which is implemented as an enhancement of GSM/GPRS, which makes it easier for existing GSM operators to upgrade to it, UMTS Universal mobile telecommunications system (acronym for Universal Mobile Telecommunications System) it is one of the technologies used by third-generation mobiles, successor to GSM, because the current GSM technology itself could not follow an evolutionary path to provide services considered to be third generation services, and/or LTE (acronym for Long Term Evolution) defined by some as an evolution of the UMTS standard (3G, which is the acronym used to refer to the third generation mobile telephone technologies), and by others as a new concept of evolutionary architecture (4G acronym to refer to the fourth generation) and/or Satellite if what is intended is full coverage of what is known as the mobile communication module (MCM) (C, FIG. 3), which enables the transmission of information in both directions by means of a mobile network to the CCS (FIGS. 4 and 8).

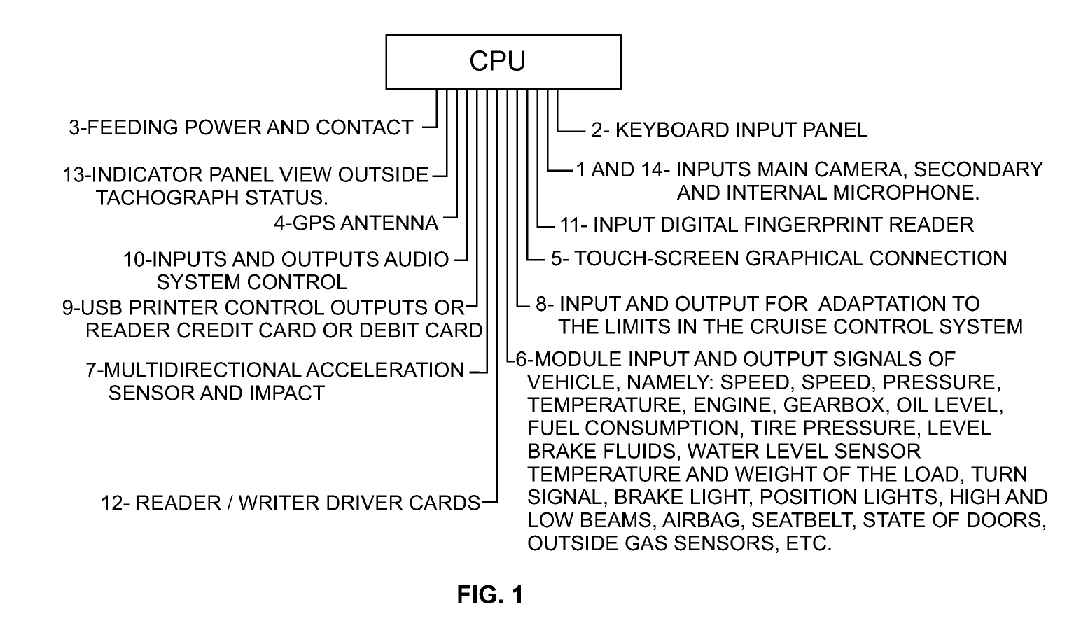

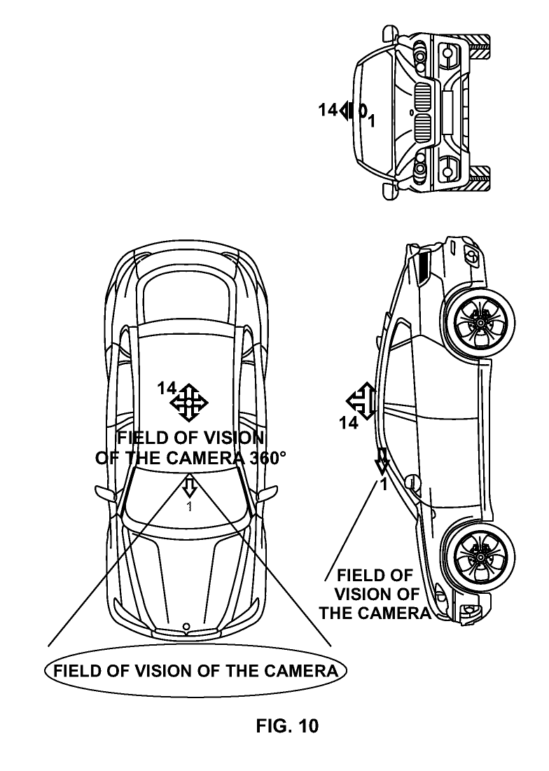

3) One or more cameras (1 and 14, FIGS. 1, 2, 3 and 10) cameras for recording digital video located in the cabin of the unit and on the outside of the unit, to film the front, the rear, and both sides of the unit.

4) A multidirectional acceleration and impact sensor (7, FIG. 3).

5) Sensors or connection to existing sensors of: speed, revolutions, pressure and temperature of the engine, gearbox, oil level, fuel, tire pressure, level of brake fluid, water level, temperature sensor and sensor for weight of load, turning lights, brake lights, parking lights, high and low beams, airbag, safety belt, status of doors, gas emission sensors, etc.

6) Control of driver's card and second driver.

7) Bluetooth and/or WiFi connection plate (E, FIG. 3)

8) Panel with indicators of status of TCDT Tachograph (Normal/failure/with reports) visible from the outside the unit (13, FIGS. 1, 2 and 3).

9) A graphic display (touch screen) (5, FIGS. 1, 2 and 3).

10) A keypad (2 FIGS. 1, 2 and 3) for communication between the driver and the application of the TCDT program with keys for the activity of the driver, for control of driving hours (similar for all DT tachographs).

11) A fingerprint reader (which may or may not activate the start of the unit) (11 FIGS. 1, 2 and 3) used for PVD controls.

Start of a trip Controls:

Known as Preliminary Validation of Departure (PVD), the TCDT will control and verify the following:
Authorization to drive that unit.
Validity of driver's documentation and that it is in accordance with the rules (Nationally Valid License in accordance to the mode for which it is licensed).
Driver's card inserted in the TCDT and validation thereof.

Once these requirements are fulfilled, the TCDT will proceed to the Preliminary Validation of Departure (PVD), where it will proceed to:
Provide the Certificate or Unique Registry of Motor Transport (Registro Unico de Transporte Automotor) (RUTA)
Verify the validity of the Mandatory Technical Inspection of the unit (MTI), also known as Technical Verification of Vehicle (Verificaciem Monica Vehicular) (VTV).
Verify the validity of the different Certificates of insurance coverage in force, compulsory liability insurance, transported third party insurance, insurance on load and the risks covered. Verify payments and due dates.
Verify additional requirements uploaded onto the TCDT, based on the type of load to be transported.

Verify transport documents, waybill, guide or invoice.
Verify and validate Maximum Weights in accordance to the loading standards of the unit under control.
Provision of information concerning the restriction on the movement of the vehicle in accordance with the assigned route, dates and times of restrictions.
Verify load in the TCDT, identifications, Fiscal documentation that authorizes traffic for both national and provincial treasuries (examples: When transporting grain it is mandatory the use of the waybill issued by the giver of the load on forms approved by the relevant agencies (ONCCA, National Bureau of Agricultural Commercial Control, for its acronym in Spanish) whereby it is required to set down, where applicable, the Grain Traceability Code (CTG, for its acronym in Spanish). Any shipment of goods whose origin and destination are in said jurisdiction must be covered by the COT (Shipment Operation Code, for its acronym in Spanish), etc.

Insurance on the load, only with a transport contract, indicating on the policy the risks covered. The Insurance will be hired by:
The Shipper or consignee, who will deliver to the person who will carry out the transport operation, before loading, the regulatory coverage certificate, which will include the clause of exemption from liability of the carrier.
The person who will carry out the transport operation, charged to the giver of the load, if it is not insured under the provisions of the previous point. In this case the sender shall declare the value of the load when carrying out the dispatch, on which amount the corresponding risk rate will be paid and up to which value it will respond. No claim will be admitted for a greater value than that which was declared.
When transporting Food Substances, additional documentation is required for the unit:
   Local licensing for the transport of food substances in general.
   Licensing from SENASA (National Service of Agrifood Health and Quality) (for its acronym in Spanish: Servicio Nacional de Sanidad y Calidad Agroalimentaria) for transportation of meat and/or dairy (in accordance to SENASA Transport Regulations of Animal Products, By-Products and Derivatives of same).
   Registration of licensing of warehouses.
   Certificate of disinfection of warehouses.
When transporting Cattle
   When transporting cattle, besides all that above said for transportation of cargo in general, the equipment will control, and therefore the system must be input with:
   Valid SENASA license.
   The DTA and/or Livestock Guide for transporting animals.
If the cattle are destined for export, the system must be input with:
   Export TRI
   The certificate of Washing and Disinfection of the vehicle.
   In the case that an international transport trip is to commence, the data to be input is:
   Fiscal Documentation required for international transport is:
   Bill of Lading (CRT).
      International Cargo manifest (MIC (for its acronym in Spanish: Manifiesto internacional de carga)-DT A), Export Invoice.
   Certificate of origin of the transported product.
      Shipping permit, charged to the shipper, which would streamline and simplify border procedures.

En route Controls:

Once the vehicle starts the trip, the processor (A, FIG. 3) of the TCDT, in addition to processing the typical information of digital tachographs, using the Geographic Positioning System, (GPS and/or GLONASS, Galileo), from which it takes the time, speed, location and direction, and through the MCM module (C, FIG. 3) receives from the CCS updates of the maps uploaded onto the memory (G, FIG. 3), (maps of streets, roads and highways, and useful indications referred to traffic, dates and times of restricted traffic zones according to categories of the National Road Safety Agency (ANSV, for the acronym in Spanish: Agenda Nacional de Seguridad Vial), with these elements it will permanently process the control of the driving conditions (G, FIG. 3).

This control can identify and give notice of possible offenses of the driver (10, FIGS. 1 and 3) which, in the case of not correcting the driving, the TCDT generates an offense report which consists in reporting the fact to the driver, store the offense in the internal memory (G, FIG. 3), change the Indicator panel of the TCDT (visible from outside the unit (13, FIGS. 1, 2 and 3)) from a Normal indication to an “indication with reports” in order to be distinguished from the outside the unit by a police checkpoint on the road. Subsequently, using the MCM module (GPRS, EGPRS, UMTS, LTE type and/or satellite (C, FIG. 3)) and connecting to the RTVCS System, the TCDT will send this report to the CCS to incorporate it to the list of pending offenses of the vehicle. In the event that the unit is out of the coverage area, this report will remain in the equipment pending delivery until the vehicle enters an area with coverage and the report the report can be sent automatically. Once the report is sent, the TCDT will wait for the acknowledgment receipt from the CCS.

In order to process this and other reports, the TCDT will be permanently recording the video taken by the camera(s) (1 and 14, FIGS. 1, 2, 3 and 10) on the internal solid state memory (G, FIG. 3), and simultaneously, the TCDT will incorporate on each video frame all the information from the GPS (and/or GLONASS, Galileo) (B, FIG. 3), in addition to the controls of the equipment (driver, acceleration), as well as information of existing signals in the vehicle and which can be connected to the main unit (such as turning signals, brakes, airbags, seat belts, lights, status of doors, engine RPM, etc. (6, FIGS. 1 and 3). This video is known as the V&D video (Video and Data) and will be recording constantly with an index of date/time for searches, on to the solid state memory of the TCDT (G, FIG. 3), until the space prepared for the stored V&D video is filled, then a new V&D video recording replaces the older V&D.

This V&D video will form part of the reports, which can be:

A. Reports of Traffic offenses, which in turn can be:
Generated Automatically by the TCDT (hereafter known as AOR, Automatic Offenses Report).
Generated by the TCDT on request of the driver for offenses committed by other nearby vehicles (hereafter known as MOR, Manual Offenses Report).
Requested by the CCS for the analysis of offenses of the vehicle or of other nearby vehicles (hereafter known as ROR, Requested Offenses Report).

B. Accident Reports
i. Generated by the TCDT automatically (hereafter known as AAR, Automatic Accident Report) by analysis of the multidirectional acceleration and impact sensor of the equipment (7, FIG. 1), or detection of triggering of the airbag of the unit (6, FIG. 1). The CCS can accelerate assistance to the vehicles involved as well as notify emergency centers and all vehicles near the place of the accident, foreseeing an increase of the accident or a congestion on the highway or road.
ii. Generated by the TCDT on request of the driver due to an accident of the vehicle itself or of other nearby vehicles (hereafter known as MAR, Manual Accident Report).
iii. Requested by the CCS for the analysis of accidents of the vehicle or of other nearby vehicles (hereafter called RAR, Requested Accident Report).

The AOR and MOR Offense Reports, such as AAR and MAR Accident reports comprise a V&D video file from a time prior to the offense or accident detected automatically by the equipment or generated manually by the driver, until a time after the offense. These times can be reconfigured from the CCS.

In the reports generated by the driver (MOR and MAR), audio taken with a microphone located in the cabin can be included (1, FIG. 3).

On the other hand, the ROR Reports of traffic offenses, as well as the RAR Accident reports are reports which are requested from the CCS, and will be reports requested to all vehicles with TCDT that the system detects next to the location and on the date/time of the search of the report. The data contained in the CCS report request will be coordinates, date/time and start time and end time of the report. After receiving the request for this report, the Tachograph generates with this data a search of the stored V&D video file memory (G, FIG. 3), using the date/time index as a search item for making the ROR and RAR reports.

In FIG. 8 A it is intended to represent the currently existing systems and equipment both of private use as well as those required under Ordinance or Regulation.

Since the TCDT in its function as a Tachograph and using the MCM module and its GPS can also be configured to generate data reports for Automated Vehicle Tracking (RVA, for its acronym in Spanish: Rastreo Vehicular Automatizado), or Automatic Vehicle Location or AVL (acronym of its name in English, Automatic Vehicle location) companies, that is, as a system for remote localization in real-time of the unit for use by the company that owns the unit directly or through another company that provides tracking services for administrative or safety issues of the units or their loads, but always with control and approval of the information provided by the TCDT Tachograph by the CCS, to ensure the inviolability of the information. It is therefore proposed to in FIG. 8 B a possible criterion of use of the TCDTs for the full utilization of the information they can provide on the vehicles, thus being able to also assist or replace other control equipment currently existing and mandatory such as Speed limit control (CN), or also private or individual control equipment such as AVL, taximeters, or browsers.

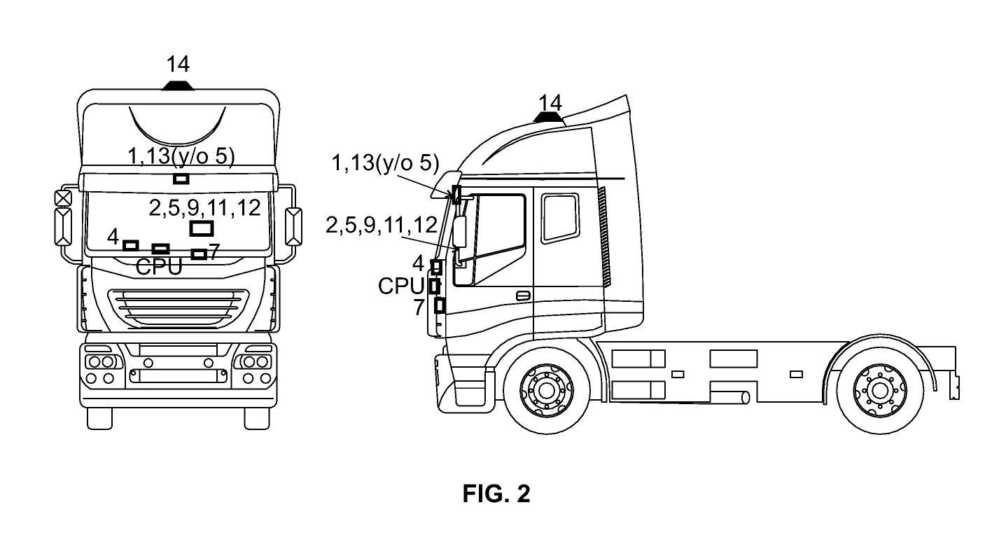

The RTVCS Control System proposed in FIG. 8 B comprises a necessary control of units on the road, which enables the control and payment of offenses. In order to carry this out, the RTVCS system must ensure that identifying the status of the TCDT on the vehicles is simple, identifying the status as active, with reports or with outstanding fines. In order to do so, the camera in the TCDT is mounted attached to the windshield (1, FIG. 2), and may be used as the support for the graphic display (5, FIG. 2) (similar to an inside rearview mirror). Together with the camera support, and looking in the same direction, are two high brightness LEDs (from the English acronym Light Emitting Diode), so that these LEDs can be seen from outside the vehicle by the supervisory authorities on public roads. A green LED indicates that the TCDT is working properly and a red LED indicates that that the vehicle has pending offenses.

Hereinafter is the way how to control the TCDT. When the vehicle reaches a police control on the highway, the police will immediately become aware of the status of the TCDT by simply looking at the two LEDs.

The RTVCS system will also provide traffic police with a CTVC Tool, which enables a “selective” control on the road of vehicles which have a TCDT with reports of existing offenses and offenses pending payment. Linking the CTVC tool with the RTVCS system enables police to anticipate the status of the TCDTs of the vehicles approaching a police control, thus avoiding stopping or hindering traffic of vehicles in good conditions and with no outstanding offenses.

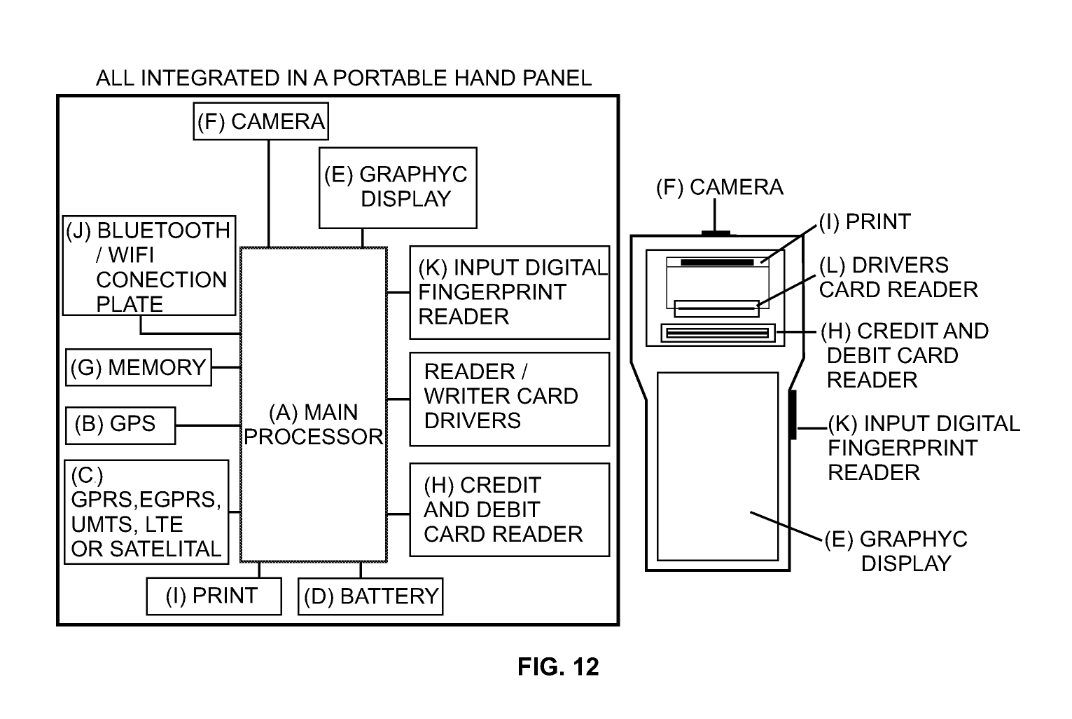

This CTVC tool can also establish a Bluetooth and/or WiFi connection (J, FIG. 12) with the TCDT of the vehicle, which enables checking the accumulated offenses of that particular vehicle, and by being connected to the RTVCS by means of a communication module MCM (C, FIG. 12), and by means of the TCDT credit or debit card reader (H, FIG. 12), payment of outstanding fines can be made, and once the RTVCS confirms payment through the central control station, the system writes off the outstanding fines of that particular vehicle, causing the TCDT of the vehicle to turns off the red warning LED.

This tool will use the fingerprint reader as a security and information means for payment transactions (K, FIG. 12).

The printer (I, FIG. 12) prints out the receipt of the transaction. This tool will also enable the reading of the Driver's card (L, FIG. 12) thus controlling compliance with driving times and resting periods, as well as the list of registered reports on the driver.

Regarding control of the equipment by the company, and taking into account the information found under the heading “state of the art”, in current Digital Tachographs, the owner of the vehicle is responsible for reading data from both the tachograph as well as from the driver's card of those drivers who have used it with sufficient frequency to prevent its loss. In addition, it is necessary to store data for a one year period and make it available to the authorities when so required. The TCDT carries this out wirelessly and independently of the information sent automatically to the CCS. This same information can be obtained by the Company using a CTVC tool similar to the one used in traffic police controls, only by using a “company key” and establishing a connection with the TCDT by means of Bluetooth and/or WiFi (J, FIG. 12); likewise, the Driver's card can be accessed to be read in order to verify compliance of driving times and resting periods, as well as the list of registered reports regarding the driver.

In a preferred embodiment of the present invention, the TCDT is represented in FIG. 1 as a diagram of its constitutive parts, and FIG. 2 shows possible locations of these constitutive parts in a given type of vehicle.

FIG. 1 shows the central element of the TCDT, a CPU for control and communication of the TCDT (3, FIG. 1) and which is shown in detail in FIG. 3.

The CPU of FIG. 3 comprises:
a. A central processor (A, FIG. 3) in charge of the entire process of analysis, operation and the linking of the TCDT with the RTVCS system (Zone A, FIG. 8), by means of the link with the CCS (FIG. 4).
b. A Geographic Positioning System GPS and/or GLONASS, Galileo (B, FIG. 3) to determine the location, speed, date, time and address of the unit, necessary to carry out an ongoing analysis of compliance with traffic laws wherever the unit is located (streets, roads or highways, uploaded and updated on the TCDT In real time).
c. An MCM module, of the GPRS, EGPRS, UMTS, LTE type or Satellite (C, FIG. 3) which enables the transmission and reception of data to and from a CCS (e.g. in Argentina it may be part of or linked to the ANSR or CNRT).
d. A battery (D, FIG. 3) to ensure the proper working of the TCDT Tachograph in every possible condition.
e. A Bluetooth and/or WiFi connection plate (E, FIG. 3) for downloading reports from the internal memory of the TCDT of the company which owns the vehicle, for adjustments in the enabled workshops, as well as for reporting controls on the road.
f. Connection to at least one camera (1, FIGS. 1, 2, 3 and 10) to capture the image in the line of sight of the driver, that is to say, on the front of the unit. The CPU supports video input of another camera (14, FIGS. 1, 2, 3 and 10), which may vary according to the use or application of the unit, or it may be a 360° image camera located on the top of the vehicle, which extends the information to the environment of the vehicle (optional). The first camera will have the TCDT status vision indicators integrated from the exterior (Normal/failure/with reports) (13, FIGS. 1, 2 and 3) and a microphone in the cabin (1, FIGS. 1, 2 and 3).
g. A solid state memory (G, FIG. 3) with a capacity to store standard data of tachographs and up to a 1 year period of activity, as well as a minimum of 48 hours of V&D video and outstanding reports.
h. A Multidirectional acceleration and impact sensor (7, FIGS. 1, 2 and 3) incorporates the information to the reports, or it is used to activate accident reports automatically. It also supports connections to existing impact sensors in the unit as well as activation warnings of airbags.
i. A Connection with graphic display (touch screen) (5, FIGS. 1, 2 and 3) with all the information and activation reports from the screen or from a keypad (2, FIGS. 1, 2 and 3), in order to enable the driver to carry out accident reports or offenses of another nearby unit.
j. The CPU has inputs for driving signaling of the unit, such as turning indicators, braking, seat belts, activation of airbags, open doors, engine RPM, etc., information which can warn the driver, as well as automatic accident reports. All the aforementioned issues are important to analyze accidents at a later date (6, FIGS. 1 and 3). The CPU will read the speed off the unit's system, as a backup to the GPS speed system and as coverage in areas where this signal is not present (e.g. in tunnels).
k. Inputs and outputs in the audio system of the unit to control warning reports for the driver (10, FIGS. 1 and 3).
l. Input and Output for speed settings configured in the cruise control system in units having an original system (8, FIGS. 1 and 3). This will be carried out by controlling the active system signal; subsequently, and while this signal is active, the system will control that the set speed does not exceed the maximum speed for this type of vehicle according to the location of where the vehicle is being used, adjustments are performed generating control pulses in the signals of the manual keys, increasing or lowering the set speed such as would be done manually, but performed by the TCDT.
m. Input and Output for the reading/writing panel for driver's cards (12, FIGS. 1, 2 and 3).

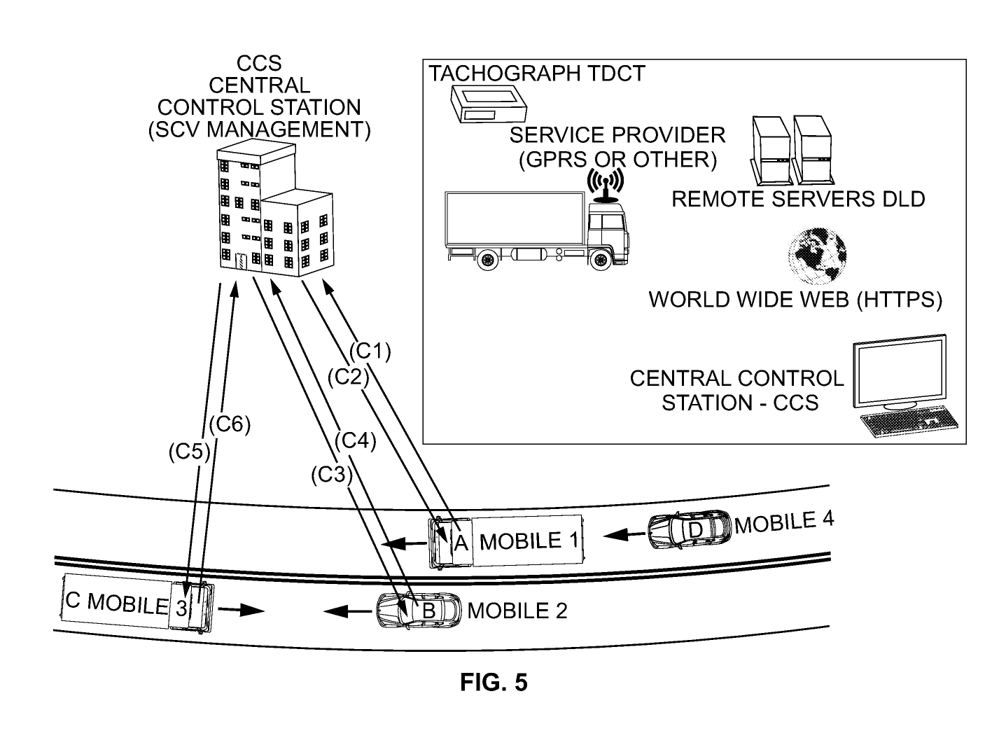

The TCDT enables offense reports of other vehicles and FIGS. 4 and 5 show examples of how these reports, input into the RTVCS system, will be processed from the CCS in order to define if the offense report is valid or not.

FIG. 4 shows an example wherein unit 1 (A) comprises a TCDT, thus, when vehicle 2 (B), commits an overtaking offense, in this example for speeding, the driver reports this offense to the CCS (C1), and the EEC sends a confirmation of the receipt of the report (C2) to the TCDT of vehicle 1 (A). In the CCS the speed difference between vehicle 1 (A) and vehicle 2 (B) is processed using the video of the report of vehicle 1, to which the speed of vehicle 1 (A) is added. This value is the speed of vehicle 2 (B) at the moment when vehicle 2 overtakes vehicle 1 (A). In order to carry out this analysis, the CCS uses maps of streets, roads and highways, limits and traffic laws, according to the type of vehicles, but added to this, to be able to carry this our, the system has uploaded a reference map of distances (distance between broken lines (G, FIG. 4) for the analysis of the TCDT V&D video of the report (see Annex 2). Thus it is possible to quantify the speed at which vehicle 2 (B) moves away from vehicle 1 (A), using the time input into the V&D video and the reference distance above mentioned, that is to say, the distance between the broken lines painted on the road (G, FIG. 4) times the number of lines vehicle 2 (B) moved away.

FIG. 5 shows an example where it is assumed there are several vehicles with TCDT Tachographs installed in them, including the vehicle which is violating the traffic law, but in this case the offense is not speeding, but overtaking in a zone where overtaking is not allowed (double line). In this case, the TCDT of vehicle 2 (G) can report the crossing over of the double line by means of an image analysis of the inner camera (1, FIGS. 1, 2, 3 and 10) in real time. In the absence of this analysis, this report can be carried out by one of the other vehicles. But if the report is given by the driver of vehicle 1 (A), the report (C1) to the CCS originates in vehicle 1 (A), and the CCS sends an acknowledgment of the reception (C2) of the report. The CCS determines the offense of vehicle 1 based on the V&D video, and the CCS requires reports from all vehicles with TCDT in the area and at that time (current if the vehicles are in the coverage area of the communication signal or at the time the offense took place if there is a delay due to not having a coverage in that area), thus the CCS requires a report from vehicle 2 (B) (which was the vehicle which committed the offense) and (C5) from vehicle 3 (C), both of which send a report (C4) and (C6) respectively. The CCS later confirms the reception of these reports and can process the offense of vehicle 2 (B) from different angles given by different vehicles automatically and give notice of the committed offense to vehicle 2 (A) in real time. Using the same criteria, an accident report from a nearby vehicle can likewise be provided.

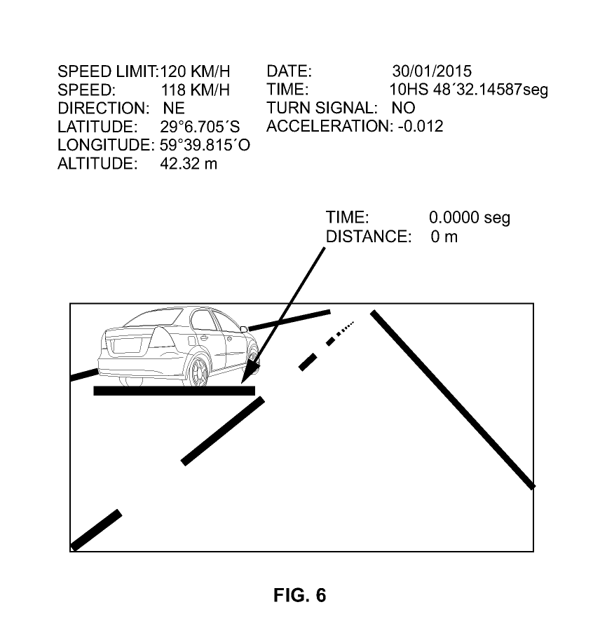

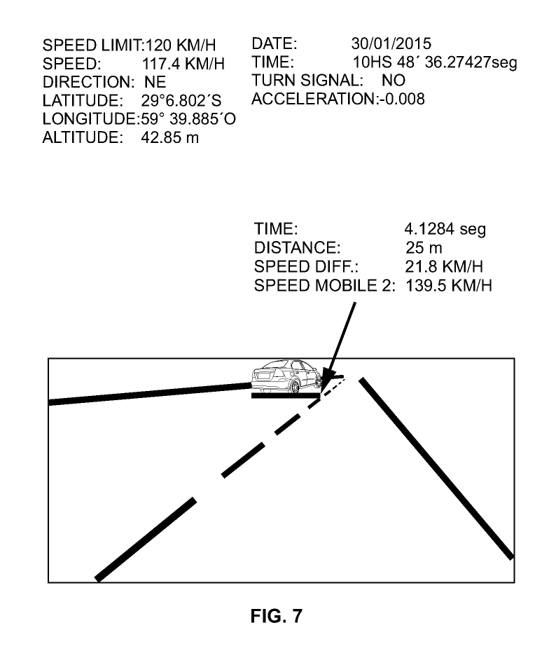

The analysis of the report comprises analyzing the V&D video as from a time prior to the offense until a time after the offense; the video has enough definition to capture the license plate of the vehicle which is charged with the offense, at least 30 frames per second, which allows for a frame by frame analysis. Taking frame 0 or the beginning of the measurement of overtaking (FIG. 6), advance is made to the last image allowed by the definition (FIG. 7) and progress is determined in meters according to the amount of white lines advanced by vehicle 2 (the distance between the lines in that location is known, as the information is taken from the road maps), which in the example was 25 meters. Considering the difference in time between these two frames (FIGS. 6 and 7), which was 4.1284 seconds, the speed difference between the two vehicles is determined, which was 21.8 km/h. This speed is added to the average speed of vehicle 1 at that time, which was 117.7 km/h, resulting in an overtaking speed of vehicle 2 of 139.5 km/h, or 19.5 km/h over the speed limit, thereby this offense remains in the CCS charged to this vehicle. It should be noted that in some countries the overtaking speed may differ from the maximum driving speed, in this case the speed limit shall be taken as the greater of the two.

Having thus specially described and determined the nature of the present invention and the way in which the same is to be put into practice, it is declared to claim as property and exclusive right:

1. A total control digital tachograph device (TCDT) to be place on a vehicle having a central processor connected to a GPS and/or a speed sensor, a solid state memory, two driver's card readers and a keypad to carry out basic functions of tachographs, which are speed control and driver's resting periods, the total control digital tachograph device comprising:
at least two cameras for video recording of a front image and an environment of the vehicle, the at least two cameras control or reports of offenses of the vehicle or nearby vehicles;
a push button and/or a touch screen from which a driver carry outs the offense report of near by vehicles;
a GPRS, a EGPRS, a UMTS, a LTE type and/or satellite communication module to transmit information in both directions through a vehicle telephone network to a central control station (CCS) by using a real time vehicle control system (RTVCS);
a bluetooth/WiFi connection plate to download reports from an internal memory of the total control digital tachograph device, information from driver's cards as well as to connect with other systems such as a load temperature control system in thermal trailers, incorporating the information as required information reports in certain countries, how to link up with the TCDT of other vehicles for transit in caravan, or to receive reports from traffic control elements, such as intelligent traffic lights, and receive status indication reports based on the directions, and through the TCDT may give notice of detention or activate an offense report in case it is not respected;
a feeding system by continuous positive contact and also by internal battery to ensure operation;
a data input and an output module including a plurality of sensors such as speed, revolutions, pressure and temperature sensors on an engine, ABS, airbag, turning lights, brake lights, parking lights, high and low beams, seat belt, status of doors, load temperature and weight sensor, seat belt, status of doors, tire pressure, fuel sensors, and gas emission sensors among others;
several inputs and outputs for the cruise control, which would allow to drive within the speed limits automatically;
audio inputs and outputs;
fingerprint reader; and
external display panel with information about the status of the TCDT;
wherein the elements generate a change in control criteria since they incorporate controls previous to the start of the trip, both of the vehicle and a load, as well as control of the driver, and also generate a total control of the driving based on the traffic laws for the location of where the vehicle is being used, as well as warning the driver if he begins to drive incorrectly, such as recording fines if the driver does not correct the driving, as well as enabling to carry out the control of other vehicles in its environment, in a field of vision of the driver, and also turn the controlled vehicle into a controller of other vehicles, the driver of being constantly monitored and thus have a greater obligation to comply with traffic laws, reducing accidents.

2. The device according to claim 1, wherein the device further includes a GPS, a Galileo and/or GLONASS positioning system, to a read time, a speed, a location and a direction, in addition includes a solid state memory to record and update maps of streets, roads, and highways, control limits, and traffic laws thereof, through the ongoing processing of this information the device automatically analyze and give notice of possible offenses of the vehicle and in the case of not correcting the driving according the limits set, automatically send a report of the offense of the unit to the central control station by using the communication module, the report comprises a video file and associated data (V&D) from a time prior to the report until a time after the report.

3. The device according to claim 1, further including a push button to allows the driver to generate reports of offenses of the nearby vehicles, offenses which are identifiable at a glance, such as overtaking on a double line, red lights, violation of road signs, speed limits; jointly with an audio message which is recorded by a microphone incorporated into the device, turning the vehicle into a controller.

4. The device according to claim 1, further including a multidirectional acceleration and impact sensor to generate a breakdown or accident report in the vehicle, breakdown or accident report is generated automatically or manually using a keypad or a graphic display or touch screen. This enables to control the severity of the accident from the CCS, and to send aid or assistance to the unit.

5. The device according to claim 1, further including a mobile communications module to transmit information in both directions, by using the mobile communications module the device sends reports and allows the central control station CCS to automatically request reports from the device TCDT of the vehicle when an offense, a failure, or an accident from the nearby vehicle is generated, which links the presence of the vehicle by location, date and time of the offenses or accident report of the nearby vehicle, enabling an analysis from different angles of all the nearby vehicle near the vehicle.

6. The device according to claim 1, further including several inputs and outputs for the cruise control of the vehicle to adjust a selected setting of the speed to the limits of the road or highway, increasing or decreasing the speed accordingly, to drive respecting the limits in a simple manner, and using the touch screen, provide assistance with notifications and warnings during a trip, having additionally updated maps in real-time with traffic information, accidents, repairs of roads, fog, smoke, whereby the possibilities of accidents as well as delays on the road or due to traffic are minimized.

7. The device according to claim 1, wherein the bluetooth/WIFI connection plate a communication module to connected to the real time vehicle control system (RTVCS) to receive information on the vehicle before the vehicle arrives and allowing a selective control of vehicles, such as payment of outstanding traffic offenses.

8. (canceled)

9. The device according to claim 1, further including pre-trip controls with a fingerprint reader which checks fingerprints against those stored in the memory, and which the device has to recognize; readers and recorders for the driver's card.

10. The device according to claim 1, further including a mobile communication module (MCM) that with the GPS generate data reports for an automated vehicle tracking device (AVT), or an automated vehicle localization device, or automatic vehicle location device AVL for remote localization of the vehicle in real-time.

11. The device according to claim 1, further including two USB outputs for connection to a printer, fax, or credit or debit card reader.

12. (canceled)

13. The device according to claim 1, wherein the feed system for the is a permanent positive contact as well as an internal battery which is rechargeable.

14. A total control digital tachograph device (TCDT) for vehicle control providing information in real and/or delayed time to a control center (CCS) comprising:
a data processing unit comprising inputs and/or outputs of information from and/or to:
one or more cameras to record high-definition video in real time by using a video interface;
a touch screen graphic video display,
a communications module (MCM), for connection to a central station by means of GPRS, EGPRS, UMTS, LTE network or satellite;
a global positioning system with an antenna;
an external indicator panel to indicate the status of the device;
a driver's card and credit card reading unit and printer;
a fingerprint sensor;
an external battery power feed;
a bluetooth/WiFi connection plate,
a digital memory;
an audio input and output unit for communication with the control center CCS;
USB connection units; and
input and output unit of control data referred to operation of the vehicle;
by proxy
